(19) United States
(12) Patent Application Publication
(10) Pub. No.: US 2007/0266235 A1
(43) Pub. Date: Nov. 15, 2007

(54) ELECTRONIC MAIL CREATION DEVICE, ELECTRONIC MAIL CREATION METHOD, ELECTRONIC MAIL CREATION PROGRAM STORAGE MEDIUM, ELECTRONIC MAIL SENDING DEVICE, ELECTRONIC MAIL SENDING METHOD, AND ELECTRONIC MAIL SENDING PROGRAM STORAGE MEDIUM

(75) Inventor: Nobumi Kusano, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/688,300

(22) Filed: Mar. 20, 2007

(30) Foreign Application Priority Data
May 10, 2006 (JP) 2006131098

(51) Int. Cl. H04L 9/00

(52) U.S. Cl. 713/153

(57) ABSTRACT

There is provided an electronic mail creation device that includes an acceptance unit that accepts a specification of a plurality of destinations including a secret destination and a public destination; a broadcast mail creation unit that creates a broadcast electronic mail by performing encryption processing for sending data not by means of a public key certificate of the secret destination but by means of a public key certificate of the public destination and not by setting the secret destination in a “To:” destination box and a “Cc:” destination box but by setting the public destination in the “To:” destination box and the “Cc:” destination box; and a secret mail creation unit that creates a secret destination electronic mail by performing encryption processing for the sending data by means of at least the public key certificate of the secret destination and not by setting the public destination in any destination box but by setting the secret destination in one of the destination boxes.

### CROSS-REFERENCE TO RELATED APPLICATIONS

This application is based on and claims priority under 35 USC 119 from Japanese Patent Application No. 2006-131098, filed on May 10, 2006.

### BACKGROUND

1. Technical Field

The present invention relates to a technology for sending electronic mail to multiple destinations, and more particularly to a technology for encrypting electronic mail by means of a public key certificate.

2. Related Art

An electronic mail is sometimes encrypted by means of a public key certificate. That is, an attached file and the electronic mail itself are encrypted by means of the public key certificate of a destination and, in addition, the information (public key certificate identification information) for identifying this public key certificate is attached to the electronic mail.

When a destination is entered in the “Bcc:” destination box of electronic mail, the same electronic mail contents that are sent to the destinations entered in the “To:” destination box and the “Cc:” destination box are sent to the destination entered in the “Bcc:” destination box at the same time the contents are sent to the destinations entered in the “To:” destination box and the “Cc:” destination box, without notifying the destinations entered in the “To:” destination box and “Cc:” destination box. However, if this electronic mail is encrypted by means of the public key certificates of all destinations, including the destinations in the “To:” destination box, the “Cc:” destination box, and the “Bcc:” destination box, the destinations in the “To:” destination box and the “Cc:” destination box can know, via the public key certificate identification information attached to the electronic mail, that the same electronic mail message is sent to the destination entered in the “Bcc:” destination box.

### SUMMARY

According to an aspect of the invention, there is provided an electronic mail creation device that includes an acceptance unit that accepts a specification of a plurality of destinations including a secret destination and a public destination; a broadcast mail creation unit that creates a broadcast electronic mail by performing encryption processing for sending data not by means of a public key certificate of the secret destination but by means of a public key certificate of the public destination and not by setting the secret destination in a “To:” destination box and a “Cc:” destination box but by setting the public destination in the “To:” destination box and the “Cc:” destination box; and a secret mail creation unit that creates a secret destination electronic mail by performing encryption processing for the sending data by means of at least the public key certificate of the secret destination and not by setting the public destination in any destination box but setting the secret destination in one of the destination boxes.

### BRIEF DESCRIPTION OF THE DRAWINGS

Exemplary embodiment(s) of the present invention will be described by reference to the following figures, wherein:

FIG. 1 is a diagram showing an example of the general configuration of an electronic mail device;

FIG. 2 is a flowchart showing the creation and sending process of electronic mail; and

FIG. 3 is a schematic diagram showing the flow of electronic mail creation.

### DETAILED DESCRIPTION

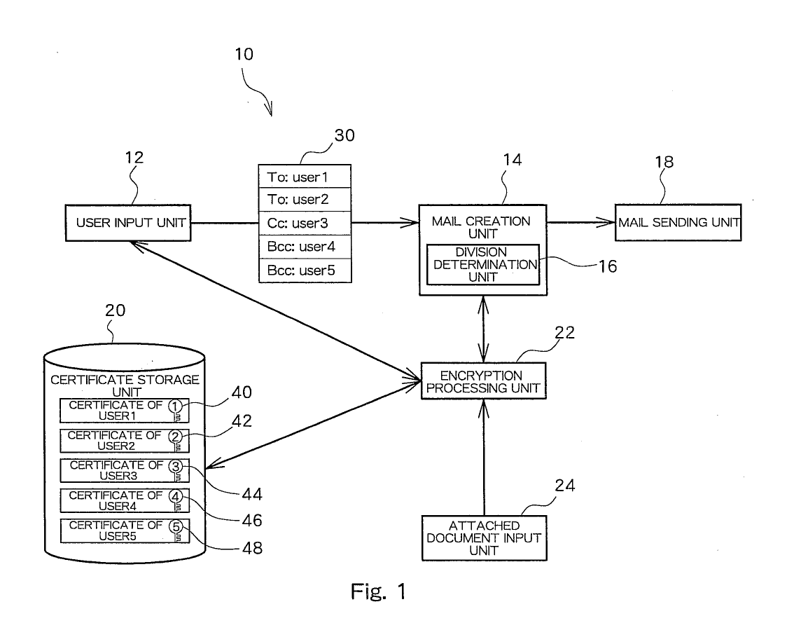

FIG. 1 is a diagram showing the general configuration of an electronic mail device 10 in this exemplary embodiment. This electronic mail device 10, a device that creates and sends electronic mail, is built from a PC connected to a network.

The electronic mail device 10 includes a user input unit 12, a mail creation unit 14, a mail sending unit 18, a certificate storage unit 20, an encryption processing unit 22, and an attached document input unit 24. The user input unit 12 is used by the user to create electronic mail and request to send the electronic mail. The mail creation unit 14 creates electronic mail by setting text, setting a destination, and attaching an attached file. This mail creation unit 14 includes a division determination unit 16. If a “Bcc:” specification is included in the specified destinations (a destination is set in the “Bcc:” destination box), the division determination unit 16 checks if the electronic mail should be divided into the electronic mail to be sent to that destination and the electronic mail to be sent to the other destinations. The mail sending unit 18 sends electronic mail created by the mail creation unit 14.

The certificate storage unit 20 stores the public key certificates of the users. The encryption processing unit 22 obtains the public key certificate of a destination user from the certificate storage unit 20 to encrypt an attached document. The attached document input unit 24 receives a document file to be attached.

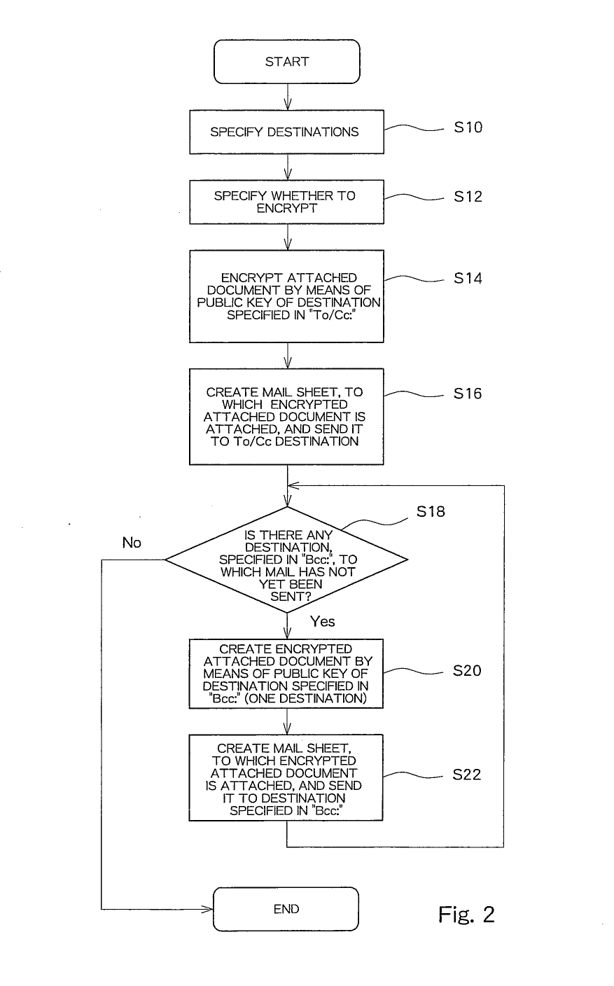

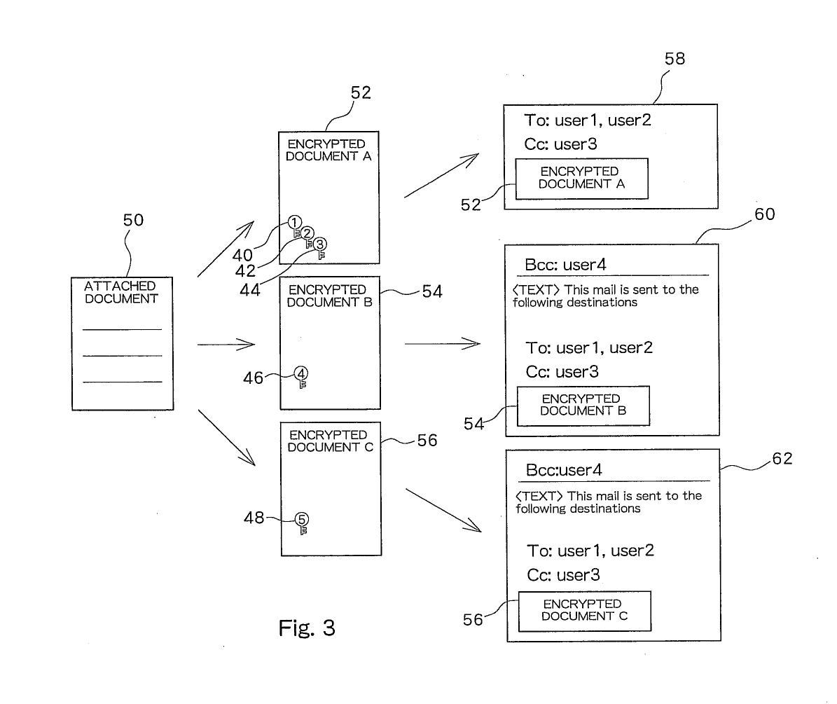

The following describes the flow of processing in the electronic mail device 10 shown in FIG. 1 with reference to the flowchart in FIG. 2 and the schematic diagram in FIG. 3. As shown in the flowchart in FIG. 2, the user specifies from the user input unit 12 an attached document and text as data to be sent, destinations (S10), and whether to encrypt the attached file (S12). A destination list 30 shown in FIG. 1 is an example of entered destinations composed of “user1” and “user2” specified in the To box, “user3” specified in the Cc box, and “user4” and “user5” specified in the Bcc box. The destination list 30 is sent to the mail creation unit 14.

A division determination unit 16, included in the mail creation unit 14, references the destination list 30 to determine in what units the electronic mail is to be created. More specifically, the division determination unit 16 determines that the electronic mail is created first for the destinations specified in the To box and the Cc box. After that, the mail creation unit 14 requests the encryption processing unit 22 to encrypt the attached document by means of the public key certificates of “user1” and “user2” specified in the To box and the public key certificate of “user3” specified in the Cc box.

The encryption processing unit 22 obtains those public key certificates from the certificate storage unit 20 (or from a directory service on the network if the public key certificates are not stored in the certificate storage unit 20). The encryption processing unit 22 also obtains an attached document 50, shown in FIG. 3, from the attached document input unit 24. The encryption processing unit 22 encrypts the attached document by means of public keys 40, 42, and 44 included in the public key certificates and attaches the public key certificate identification information to the encryption results to generate an encrypted document A 52 (S14).

The mail creation unit 14 receives the encrypted document A 52 and attaches it to the electronic mail. The mail creation unit 14 sets “user1” and “user2” in the “To:” destination box, and “user 3” in the “Cc:” destination box, to create an electronic mail 58 shown in FIG. 3. S/MIME encryption may also be performed for the electronic mail 58 as necessary. The created electronic mail 58 is a broadcast mail to be sent to the three destinations at the same time. The electronic mail 58 is sent by the mail sending unit 18 (S16). The electronic mail 58 is the same electronic mail that is created when the user does not specify Bcc, and the destinations are not aware that Bcc is specified.

Next, the division determination unit 16 checks if the destination list 30 contains a Bcc destination to which mail has not yet been sent (S18). If the result of checking shows no such destination, the division determination unit 16 terminates the processing; if there is such a destination, the division determination unit 16 requests the mail creation unit 14 to create electronic mail to be sent to the Bcc destination.

In the example destination list 30 shown in FIG. 1, the electronic mail to be sent to Bcc-specified “user4” is created first in accordance with this principle. That is, the encryption processing unit 22 obtains the public key certificate of “user4” from the certificate storage unit 20 and encrypts the attached document by means of its public key 46. As a result, an encrypted document B 54 shown in FIG. 3 is created (S20).

The mail creation unit 14 creates an electronic mail 60 with this encrypted document B 54 attached and with “user4” set in the “Bcc:” destination box. A non-confidential destination, such as the mail address of the sender, is set in the “To:” destination box of the electronic mail 60 as necessary. In addition, the mail creation unit 14 adds a message, which indicates that this mail (or mail similar to this mail) is sent to “user1,” “user2,” and “user3,” in the first part of the text of the electronic mail 60. Note that the message does not mention that the electronic mail is sent also to “user5,” which is another Bcc destination. This is because, as with the normal Bcc setting, confidentiality must be assured among the Bcc destinations. The electronic mail 60 created in this manner is sent by the mail sending unit 18 (S22).

The same processing is repeated for all destinations specified in the Bcc box. In this example, an encrypted document C 56, encrypted by means of a public key 48 of “user5,” is created and an electronic mail 62 to which the encrypted document C 56 is attached is sent to “user5” as shown in FIG. 3.

Next, the following describes several variations of this exemplary embodiment. Some of the above description may be repeated below.

An electronic mail creation device may be built from hardware that has the operation function and the storage function and software that controls the hardware operation. The electronic mail creation device may be built as a centralized processing system using one piece of hardware or as a distributed processing system using multiple pieces of hardware that can communicate with each other.

An acceptance unit can accept the specification of sending data, which are data to be sent by mail, and the specification of multiple destination settings. The sending data are data that can be sent as the text/subject of electronic mail or an attached file, or may be data generated internally in the electronic mail device or entered externally. The destination usually refers to a mail address specified in the electronic mail destination box. An address associated with a mail address, such as an alias name, may also be used as the destination. The specification of settings specifies multiple destinations that include both secret destinations and public destinations. A secret destination, which is an address used to send electronic mail without indicating to the other recipients that the electronic mail has been sent to that destination, is usually entered in the “Bcc:” destination box. A public address, which is an address that may be made public to other recipients when electronic mail is sent to that destination, is usually entered in the “To:” destination box and the “Cc:” destination box. Although the source mail address of electronic mail is sometimes entered in the “Cc:” destination box for management reasons, such an internal-use destination is not a public address. In other words, such an internal-use destination may be specified in the destination box of a broadcast electronic mail or a secret destination electronic mail. The acceptance unit can also accept the specification of encryption using a public key certificate. For example, electronic mail or sending data may be encrypted.

A broadcast mail creation unit can create a broadcast electronic mail in which sending data are included as text or an attached file. In creating a broadcast electronic mail, the broadcast mail creation unit encrypts electronic mail by means of the public key certificate of a public destination, rather than the public key certificate of a secret destination. If there are multiple public destinations, the public key certificates of all public destinations are used for encryption. In this case, public key certificate identification information for identifying a public key certificate that is used is attached to the encrypted data. The broadcast mail creation unit can set a public destination in the “To:” destination box or the “Cc:” destination box of a broadcast electronic mail. If there are multiple public destinations, the broadcast mail creation unit does not create an electronic mail separately for each public destination but sets all public destinations in the same electronic mail. Therefore, the created broadcast electronic mail is a “broadcast” mail that is sent to all public destinations at the same time. However, if there is only one public destination, only that public destination is set as the destination. Although a secret destination may be set in the “Bcc:” destination box, the secret destination cannot decrypt the encrypted result and, therefore, it is not usually set in any destination box.

A secret mail creation unit can create a secret destination electronic mail in which sending data are included as text or an attached file. Therefore, a secret destination electronic mail has substantially the same contents as those of a broadcast electronic mail. In creating a secret destination electronic mail, the secret mail destination unit encrypts electronic mail by means of at least the public key certificate of a secret destination. That is, the unit encrypts the electronic mail so that the secret destination can decrypt the electronic mail by means of its private key. In setting a destination, not a public destination, but a secret destination, is set in the destination box. A secret destination may be entered in the “Bcc:” destination box, or in the “To:” destination box and the “Cc:” destination box. Because electronic mail usually requests that the “To:” destination box be provided, a secret destination may be entered in the “To:” destination box. Alternatively, to clearly indicate that electronic mail is sent with a destination entered in the “Bcc:” destination box, it is also possible to enter a secret destination in the “Bcc:” destination box and to enter a non-confidential destination, such as the mail address of the sender, in the “To:” destination box.

The electronic mail creation device may also include a sending unit that sends a created broadcast electronic mail and a created secret destination electronic mail. This configuration allows building of an electronic mail device capable of creating and sending electronic mail.

In one mode of the electronic mail creation device of the present invention, the secret mail creation unit sets the public destination in the secret destination electronic mail so that the public destination is displayed in a position other than the destination boxes in the secret destination electronic mail. The position where the public destination is set may be in the header of the mail, in an attached file, or in the mail text or the subject (for example, the first part of the mail text).

In one mode of the electronic mail creation device of the present invention, the device comprises an acquisition unit that acquires an unsent electronic mail; a checking unit that, when a mail address of a non-sender is set in a “To:” destination box or a “Cc:” destination box and in a “Bcc:” destination box of the acquired unsent mail and when encryption is performed for the unsent electronic mail by means of a public key certificate, checks if public key certificate identification information on the destination, which is set in the “Bcc:” destination box, is included in the unsent mail; and a determination unit that determines whether or not the unsent electronic mail is to be sent, on the basis of a result of the checking of the checking unit.

Not to send electronic mail means that the electronic mail is not sent automatically. When the electronic mail is not sent, it is possible to discard unsent electronic mail or to issue a warning to the user and send the electronic mail in response to a user instruction. In addition, the device may also include a unit that divides unsent mail into mail to be sent to the destinations specified in the “To:” destination box or the “Cc:” destination box (corresponds to broadcast electronic mail described above) and mail to be sent to the destinations specified in the “Bcc:” destination box (corresponds to secret destination electronic mail described above). The sending data before being encrypted, if required for the division, may be obtained as necessary.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. An electronic mail creation device comprising:
an acceptance unit that accepts a specification of a plurality of destinations including a secret destination and a public destination;
a broadcast mail creation unit that creates a broadcast electronic mail by performing encryption processing for sending data not by means of a public key certificate of the secret destination but by means of a public key certificate of the public destination and not by setting the secret destination in a “To:” destination box and a “Cc:” destination box but by setting the public destination in the “To:” destination box and the “Cc:” destination box; and
a secret mail creation unit that creates a secret destination electronic mail by performing encryption processing for the sending data by means of at least the public key certificate of the secret destination and not by setting the public destination in any destination box but by setting the secret destination in one of the destination boxes.

2. The electronic mail creation device according to claim 1, wherein
the secret mail creation unit sets the public destination in the secret destination electronic mail so that the public destination is displayed in a position other than the destination boxes in the secret destination electronic mail.

3. The electronic mail creation device according to claim 1 wherein
if there are a plurality of the secret destinations, the secret mail creation unit creates the secret destination electronic mail for each of the secret destinations and performs the encryption, not by means of the public key certificates of the other secret destinations, but by means of the public key certificate of the secret destination.

4. The electronic mail creation device according to claim 1, wherein
the sending data includes an attached file, and
the encryption processing performed by the broadcast mail creation unit and the secret mail creation unit is processing for encrypting the attached file.

5. The electronic mail creation device according to claim 1, wherein
the encryption processing performed by the broadcast mail creation unit is processing for encrypting the broadcast electronic mail in which the sending data are included, and
the encryption processing performed by the secret mail creation unit is processing for encrypting the secret destination electronic mail in which the sending data are included.

6. The electronic mail creation device according to claim 4, wherein
the encryption processing performed by the broadcast mail creation unit is processing for encrypting the broadcast electronic mail in which the sending data are included, and
the encryption processing performed by the secret mail creation unit is processing for encrypting the secret destination electronic mail in which the sending data are included.

7. An electronic mail creation method comprising:
accepting a specification of a plurality of destinations including a secret destination and a public destination;
creating a broadcast electronic mail by performing encryption processing for sending data not by means of a public key certificate of the secret destination but by means of a public key certificate of the public destination and not by setting the secret destination in a “To:” destination box and a “Cc:” destination box but by setting the public destination in the “To:” destination box and the “Cc:” destination box; and
creating a secret destination electronic mail by performing encryption processing for the sending data by means of at least the public key certificate of the secret destination and not by setting the public destination in any destination box but by setting the secret destination in one of the destination boxes.

8. The electronic mail creation method according to claim 7, further comprising:
when the secret mail is created, setting the public destination in the secret destination electronic mail so that the public destination is displayed in a position other than the destination boxes in the secret destination electronic mail.

9. The electronic mail creation method according to claim 7, further comprising:
if there are a plurality of the secret destinations when the secret mail is created, creating the secret destination electronic mail for each of the secret destinations and performing the encryption, not by means of the public key certificates of the other secret destinations, but by means of the public key certificate of the secret destination.

10. A computer-readable medium storing a program causing a computer to execute a process for creating an electronic mail, the process comprising:
accepting a specification of a plurality of destinations including a secret destination and a public destination;
creating a broadcast electronic mail by performing encryption processing for sending data not by means of a public key certificate of the secret destination but by means of a public key certificate of the public destination and not by setting the secret destination in a “To:” destination box and a “Cc:” destination box but by setting the public destination in the “To:” destination box and the “Cc:” destination box; and
creating a secret destination electronic mail by performing encryption processing for the sending data by means of at least the public key certificate of the secret destination and not by setting the public destination in any destination box but by setting the secret destination in one of the destination boxes.

11. The computer-readable medium storing a program causing a computer to execute a process for creating an electronic mail according to claim 10, the process further comprising:
when the secret mail is created, setting the public destination in the secret destination electronic mail so that the public destination is displayed in a position other than the destination boxes in the secret destination electronic mail.

12. The computer-readable medium storing a program causing a computer to execute a process for creating an electronic mail according to claim 10, the process further comprising:
if there are a plurality of the secret destinations when the secret mail is created, creating the secret destination electronic mail for each of the secret destinations and performing the encryption processing, not by means of the public key certificates of the other secret destinations, but by means of the public key certificate of the secret destination.

13. An electronic mail sending unit comprising:
an acquisition unit that acquires an unsent electronic mail;
a checking unit that, when a mail address of a non-sender is set in a “To:” destination box or a “Cc:” destination box and in a “Bcc:” destination box of the acquired unsent mail and when encryption is performed for the unsent electronic mail by means of a public key certificate, checks if public key certificate identification information on the destination, which is set in the “Bcc:” destination box, is included in the unsent mail; and
a determination unit that determines whether or not the unsent electronic mail is to be sent, on the basis of a result of the checking of the checking unit.

14. The electronic mail sending unit according to claim 13, wherein
the determination unit determines not to send the unsent electronic mail if the public key certificate identification information on the destination, which is set in the “Bcc:” destination box, is included.

15. An electronic mail sending method, the method comprising:
acquiring an unsent electronic mail;
when a mail address of a non-sender is set in a “To:” destination box or a “Cc:” destination box and a mail address of a non-sender is set in a “Bcc:” destination box of the acquired unsent mail and when encryption is performed for the unsent electronic mail by means of a public key certificate, checking if public key certificate identification information on the destination, which is set in the “Bcc:” destination box, is included in the unsent mail; and
determining whether or not the unsent electronic mail is to be sent, on the basis of a result of the checking.

16. The electronic mail sending method according to claim 15, the method further comprising:
determining not to send the unsent electronic mail if the public key certificate identification information on the destination, which is set in the “Bcc:” destination box, is included.

17. A computer-readable medium storing a program causing a computer to execute a process for sending electronic mail, the process comprising:
acquiring an unsent electronic mail;
when a mail address of a non-sender is set in a “To:” destination box or a “Cc:” destination box and a mail address of a non-sender is set in a “Bcc:” destination box of the acquired unsent mail and when encryption is performed for the unsent electronic mail by means of a public key certificate, checking if public key certificate identification information on the destination, which is set in the “Bcc:” destination box, is included in the unsent mail; and
determining whether or not the unsent electronic mail is to be sent, on the basis of a result of the checking.

18. The computer-readable medium storing a program causing a computer to execute a process for sending electronic mail according to claim 17, the process further comprising:
determining not to send the unsent electronic mail if the public key certificate identification information on the destination, which is set in the “Bcc:” destination box, is included.
